(19) United States
(12) Patent Application Publication
(10) Pub. No.: US 2025/0067564 A1
(43) Pub. Date: Feb. 27, 2025

(54) DEEP LEARNING BASED METHOD FOR INTEGRATING DEMAND FORECASTING AND SCHEDULING OF ONLINE RIDE-HAILING AT HUB

(71) Applicants: Chang'an University, Xi'an (CN); Beijing University of Chemical Technology, Beijing (CN); Georgia State University, Atlanta, GA (US)

(72) Inventors: Xiang LI, Xi'an (CN); Kun JIN, Beijing (CN); Ziyan FENG, Beijing (CN); Hongguang MA, Beijing (CN); Yusen XIA, Atlanta, GA (US)

(73) Assignees: Chang'an University, Xi'an (CN); Beijing University of Chemical Technology, Beijing (CN); Georgia State University, Atlanta, GA (US)

(21) Appl. No.: 18/385,423

(22) Filed: Oct. 31, 2023

(30) Foreign Application Priority Data
Aug. 21, 2023 (CN) 202311053741.1

(51) Int. Cl. G01C 21/34

(52) U.S. Cl. CPC G01C 21/3438; G01C 21/3484

(57) ABSTRACT

A deep learning based method for integrating demand forecasting and scheduling of online ride-hailing at a hub is provided. The method includes: S1, performing data processing: performing missing value filling, outlier processing and normalization processing on the historical orders of online ride-hailing and relevant feature data of the urban transportation hub; S2, performing feature screening: primarily screening the relevant features by means of a Pearson correlation test and box plot analysis, calculating an influence degree of data of each feature on the orders of online ride-hailing by using an XGBoost algorithm, and secondarily screening the features; S3, performing model construction: constructing an integrated model for demand forecasting and scheduling decision of online ride-hailing at the urban transportation hub; and S4: performing algorithm design: designing a decision tree and deep learning combination algorithm, and calculating the number of online hailed rides to be scheduled.

### CROSS REFERENCE TO THE RELATED APPLICATIONS

This application is based upon and claims priority to Chinese Patent Application No. 202311053741.1, filed on Aug. 21, 2023, the entire contents of which are incorporated herein by reference.

### TECHNICAL FIELD

The present invention relates to the technical field of urban traffic management, in particular to a deep learning based method for integrating demand forecasting and scheduling of online ride-hailing at a hub.

### BACKGROUND

As the distribution center of passengers, the urban transportation hub plays an important role in organizing, coordinating, serving, distributing and transferring passengers in the process of passenger transportation, and is an important part of the transportation system. However, transportation hubs frequently face surges in the number of arrivals, resulting in large numbers of people being stranded, which causes inconvenience to passengers and poses significant safety risks. With features of flexibility and efficiency, online ride-hailing service assumes an important role in evacuating the arrival passenger flow at transportation hubs. Therefore, when a transportation hub encounters a large-scale arrival passenger flow, forecasting the online ride-hailing demand and scheduling online hailed rides around to the transportation hub to provide services in advance can effectively evacuate the arrival passenger flow and ensure the normal operation level of the urban transportation hub.

However, the online ride-hailing demand is affected by many factors, such as weather and arrival passenger flow, and has a certain degree of uncertainty and randomness. The demand for online hailed rides on different days, like workdays, off days, and special holidays, also varies greatly. How to accurately forecast the online ride-hailing demand by considering multiple factors and determine the optimal scheduling number of online hailed rides is crucial for the management of evacuation of arrival passenger flow in urban transportation hubs.

Therefore, there is a need to provide a deep learning based method for integrating demand forecasting and scheduling of online ride-hailing at a hub to solve the above problems.

### SUMMARY

An objective of the present invention is to provide a deep learning based method for integrating demand forecasting and scheduling of online ride-hailing at a hub, which can make online decision on the optimal scheduling number of online hailed rides according to the historical orders of online ride-hailing and relevant feature data, so as to effectively evacuate arrival passenger flow at an urban transportation hub.

In order to achieve the above objective, the present invention provides a deep learning based method for integrating demand forecasting and scheduling of online ride-hailing at a hub, including:
S1, performing data processing: performing missing value filling, outlier processing and normalization processing on the historical orders of online ride-hailing and relevant feature data of the urban transportation hub;
S2, performing feature screening: primarily screening the relevant features by means of a Pearson correlation test and box plot analysis, calculating an influence degree of data of each feature on the orders of online ride-hailing by using an XGBoost algorithm, and secondarily screening the features;
S3, performing model construction: constructing an integrated model for demand forecasting and scheduling decision of online ride-hailing at the urban transportation hub; and
S4, performing algorithm design: designing a decision tree and deep learning combination algorithm, and calculating the number of online hailed rides to be scheduled.

Preferably, in S1, as for missing values and outliers in the data, a mean value of data in the same periods in previous three weeks is used for filling or correction, and min-max normalization processing is performed on the orders of online ride-hailing and the relevant feature data.

Preferably, in S2, Pearson correlation coefficients between continuous time series features and the number of orders are calculated, and features with Pearson coefficients greater than a threshold are retained; and
as for calendar information or binary variable features, box plots are used for visual display, features with obvious differences in mean values and quantiles displayed in different dates or different binary variables are retained, the XGBoost algorithm is used for secondarily screening the relevant features, influence degrees of the preliminarily screened features on the orders of online ride-hailing are calculated and sorted, and some features with accumulated proportion of influence features beyond a threshold are selected.

Preferably, in S3, a Cobb-Douglas function is used for describing a supply-demand matching process for online ride-hailing with a formula expressed as follows:

$$m ( s , d ) = ⌈ a \times {s}^{{b}_{1}} \times {d}^{{b}_{2}} ⌉$$

where d is the number of orders of online ride-hailing; s is the supply number of online hailed rides; m is the number of matching successes between the supply number s and the number d of orders; a is a matching technical level; and b₁ and b₂ are matching elastic coefficients;
a benefit R of scheduling decision is maximized as follows:

$$R ( s , d ) = α \times m ( s , d ) - β \times s$$

where α is commission drawn by a platform from each matched order, and β is unit cost of the platform scheduling an online hailed ride to the transportation hub; and
the following integrated model for demand forecasting and scheduling decision of online ride-hailing is constructed, optimal w* and b* are trained based on xₙ, x and d, and a trained deep neural network θ(xₙ,d;w*,b*) is used for calculating the number s* of online hailed rides to be scheduled at present:

$$( {w}^{⋆} , {b}^{*} ) = {arg max}_{w , b} {\sum }_{n = 1}^{N} w ( {x}_{n} , x ) R ( θ ( {x}_{n} , d ; w , b ) , {d}_{n} )$$

where xₙ is historical relevant feature data, x is current relevant feature data, w(xₙ, x) is a weight value of the nth historical orders of online ride-hailing, d={d_{n-L}, . . . , dₙ₋₂,dₙ₋₁}) is the historical orders of online ride-hailing with a lag order L, and θ(xₙ,d;w,b) is a deep neural network containing a weight value w and a threshold b.

Preferably, S4 specifically includes:
S4A, based on a tree structure, determining a similarity between the historical data xₙ of the features and the current data x of the features layer by layer from the top;
S4B, allocating number-of-orders data with a higher feature similarity to the same branch; and
S4C, using a deep learning algorithm VMD-CNN-BiLSTM-AM for mining a complex nonlinear relation between the relevant features and the number of orders, where the VMD-CNN-BiLSTM-AM algorithm combines variational modal decomposition (VMD), a convolutional neural network (CNN), a bidirectional long-short-term memory neural network (BiLSTM) and an attention mechanism AM, and specific steps are as follows:
S4C1, on the premise of not changing a time correlation, using VMD to decompose the original number-of-orders data into a plurality of time series data with different frequencies, that is, intrinsic mode function IMF;
S4C2, for each IMF, training a deep neural network CNN-BiLSTM-AM with a goal of maximizing the benefit R of scheduling decision of online ride-hailing, to obtain optimal w* and b*;
S4C3, for each trained deep neural network θ_{IMF}(xₙ,d;w*,b*), inputting the corresponding historical number of orders and relevant feature data, and obtaining the number s_{IMF} of online hailed rides to be scheduled under each IMF; and
S4C4, adding the number of the online hailed rides obtained under each IMF, and finally obtaining the current number s* of online hailed rides to be scheduled.

Preferably, in S4B, a branch assigned to x is denoted as B(x), a weight of the historical number of orders belonging to the same branch as x is denoted as

$$\frac{1}{\vert B ( x ) \vert} ,$$

and the weight of the historical number of orders is denoted as 0, and a formula is expressed as follows:

$${w}_{DT} ( {x}_{n} , x ) := \frac{I \{ {x}_{n} ∈ B ( x ) \}}{\vert B ( x ) \vert} ,$$

where I(x) is an indicator function, is equal to 1 when xₙ∈B(x) is true, and is equal to 0 when xₙ∈B(x) is false.

Therefore, the present invention uses the above deep learning based method for integrating demand forecasting and scheduling of online ride-hailing at a hub, and has beneficial effects as follows:

(1) The present invention reduces an information loss in a ride-hailing scheduling decision process, omits intermediate links, and prevents a forecast error from being further amplified in the decision stage.

(2) A decision tree algorithm in the present invention is configured to determine an influence weight of each historical number of orders on the current number of orders; and a deep learning algorithm VMD-CNN-BiLSTM-AM focuses on mining a relation between relevant features and the number of orders.

(3) The present invention can directly make online decision on the optimal scheduling number of online hailed rides according to the historical orders of online ride-hailing and relevant feature data, so as to effectively evacuate arrival passenger flow at an urban transportation hub.

The technical solution of the present invention will be further described in detail by means of the accompanying drawings and examples.

### BRIEF DESCRIPTION OF THE DRAWINGS

FIGS. 1A and 1B show a flowchart of a deep learning based method for integrating demand forecasting and scheduling of online ride-hailing at a hub according to the present invention, where the bottom of FIG. 1A is connected to the top of FIG. 1B by the arrow symbol at the bottom of FIG. 1A; and

FIG. 2 is a schematic diagram of an IMF obtained by decomposing data of the orders of online ride-hailing by means of variational modal decomposition (VMD) according to the present invention.

### DETAILED DESCRIPTION OF THE EMBODIMENTS

The technical solution of the present invention will be further elaborated hereafter in conjunction with accompanying drawings and examples.

Unless otherwise defined, technical or scientific terms used in the present invention are to be given their ordinary meaning as understood by those of ordinary skill in the art to which the present invention belongs.

Words “comprise” or “include” and the like used in the present invention mean that the elements listed before the word cover the elements listed after the word, and do not exclude the possibility of also covering other elements. Terms “inner”, “outer”, “upper”, “lower”, etc. indicate azimuthal or positional relations based on those shown in the drawings only for ease of description of the present invention and for simplicity of description, and are not intended to indicate or imply that the referenced device or element must have a particular orientation and be constructed and operative in a particular orientation, and thus may not be construed as a limitation on the present invention. When the absolute position of the described object changes, the relative positional relation may also change accordingly. In the present invention, unless otherwise clearly specified, the terms “attach”, etc. should be understood in a board sense. For example, attach may be a fixed connection, a detachable connection, an integral connection, a direct connection, or an indirect connection by using an intermediate medium, or may be intercommunication between two elements, or an interworking relation between two elements. Those of ordinary skill in the art may understand specific meanings of the foregoing terms in the present invention based on a specific situation.

### Embodiment

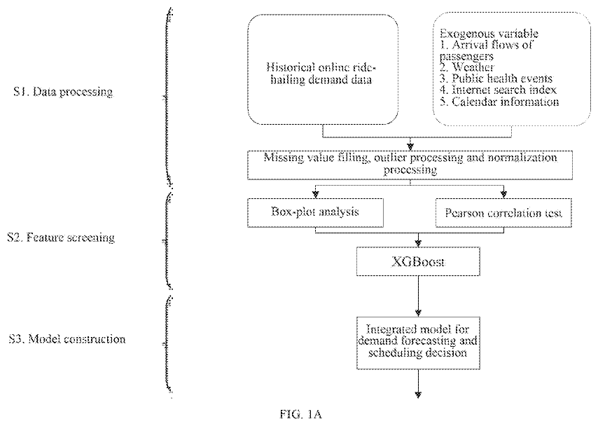

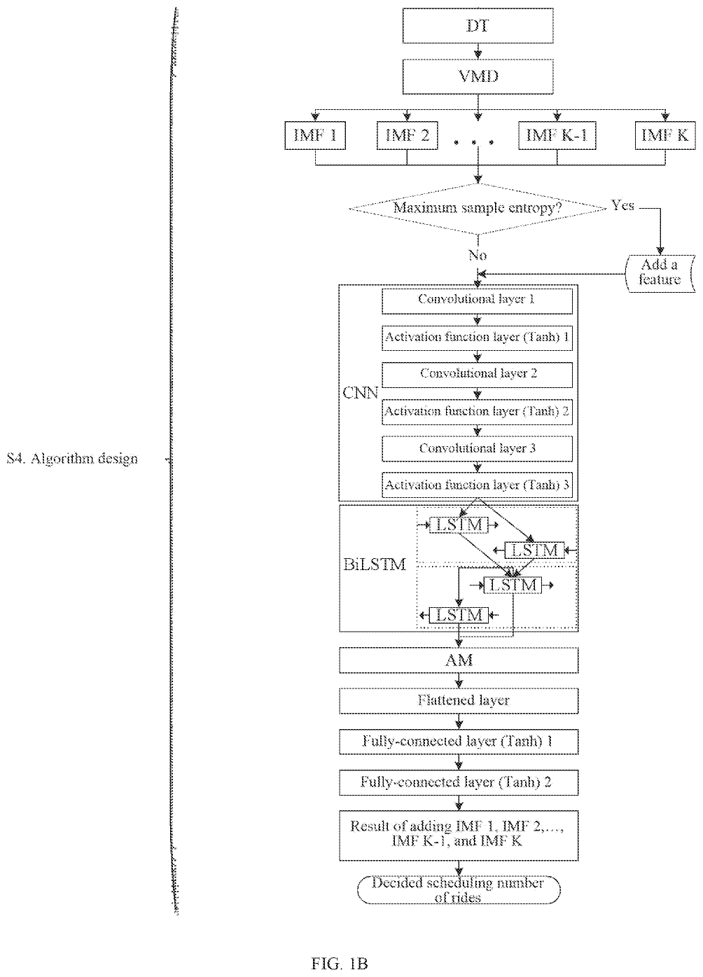

As shown in FIGS. 1A and 1B, the present invention provides a deep learning model based method for forecasting online ride-hailing short-term demand, including:

S1, data processing: data of the orders of online ride-hailing at a certain urban transportation hub in the past 212 days, as well as relevant feature data such as arrival passenger flow, weather, public health events, Internet search index, calendar information, etc. are processed. As for missing values, a mean value of data in the same periods in previous three weeks is used for filling. As for outlier identification, a visual graph method may be used to identify abnormal high values and abnormal low values, and a mean value of data in the same periods in previous three weeks is used for correction. Finally, min-max normalization processing is performed on the orders of online ride-hailing and the relevant feature data.

S2, feature screening: as for a continuous time series feature, a Pearson correlation coefficient between the continuous time series feature and the number of orders is calculated, and the feature with a Pearson coefficient greater than 0.2 is retained. As for calendar information or binary variable features, box plots are used for visual display, features with obvious differences in mean values and quantiles displayed in different dates or different binary variables are retained. On this basis, an XGBoost algorithm is used for secondarily screening the relevant features, influence degrees of the preliminarily screened features on the orders of online ride-hailing are calculated and sorted, and some features with accumulated proportion of influence features beyond 55% are selected.

S3, model construction: an integrated model for demand forecasting and scheduling decision of online ride-hailing at the urban transportation hub is constructed; and a Douglas function is used for describing a supply-demand matching process for online ride-hailing with a formula expressed as follows:

$$m ( s , d ) = ⌈ a \times {s}^{{b}_{1}} \times {d}^{{b}_{2}} ⌉$$

where d is the number of orders from passengers; s is the supply number of online hailed rides; m is the number of matching successes between the supply number s and the number d of orders; a is a matching technical level; and b₁ and b₂ are matching elastic coefficients.

Firstly, according to a market situation of online ride-hailing service, it is determined that a matching technical level in the Douglas function is a=0.5, matching elasticity coefficients are b₁=0.55, and b₂=0.55, commission drawn by a platform from each matched order is α=20 yuan, and unit cost of the platform scheduling an online hailed ride to the transportation hub is β=10 yuan. Therefore, income of a scheduling decision of the online ride-hailing platform is:

$$R ( s , d ) = 20 \times ⌈ 0.5 \times {s}^{0.55} \times {d}^{0.55} ⌉ - 10 \times s$$

In order to determine the number s of online hailed rides to be scheduled at present, the following integrated model for demand forecasting and scheduling decision of online ride-hailing is constructed:

$$( {w}^{⋆} , {b}^{*} ) = {arg max}_{w , b} {\sum }_{n = 1}^{212} w ( {x}_{n} , x ) R ( θ ( {x}_{n} , d ; w , b ) , {d}_{n} ) ,$$

where d={dₙ₋₇, . . . , dₙ₋₂,dₙ₋₁} is the historical orders of online ride-hailing with a lag order of 7, w(xₙ,x) is a weight value of the nth historical number of orders, and θ(xₙ,d;w,b) is a deep learning framework containing a weight w and a threshold b.

S4: algorithm design: a decision tree and deep learning combination algorithm is designed, and the number of online hailed rides to be scheduled is calculated. S4 specifically includes:
S4A, based on a tree structure, a similarity between the historical data xₙ of the features and the current data x of the features is determined layer by layer from the top.
S4B, number-of-orders data with a higher feature similarity is allocated to the same branch; where in S4B, a branch assigned to x is denoted as B(x), the branch includes 4 data, a weight of the historical number of orders belonging to the same branch as x is denoted as ¼, and the weight of the historical number of orders is denoted as 0, and a formula is expressed as follows:

$${w}_{DT} ( {x}_{n} , x ) := \frac{I \{ {x}_{n} ∈ B ( x ) \}}{\vert B ( x ) \vert} ,$$

where I(x) is an indicator function, is equal to 1 when xₙ∈B(x) is true, and is equal to 0 when xₙ∈B(x) is false.

S4C, a deep learning algorithm VMD-CNN-BiLSTM-AM is used for mining a complex nonlinear relation between the relevant features and the number of orders, where the VMD-CNN-BiLSTM-AM algorithm combines variational modal decomposition (VMD), a convolutional neural network (CNN), a bidirectional long-short-term memory neural network (BiLSTM) and an attention mechanism AM, and specific steps are as follows:

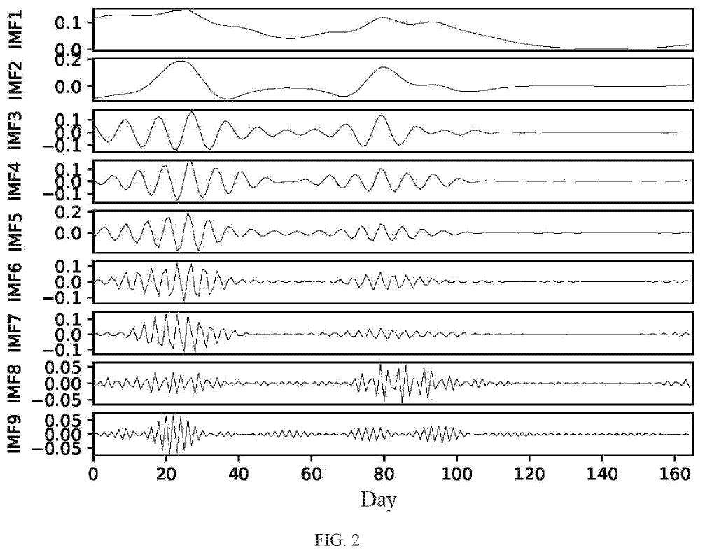

S4C1, on the premise of not changing a time correlation, VMD is used to decompose the original number-of-orders data into 9 time series data with different frequencies, that is, 9 intrinsic mode functions IMF1, IMF2, . . . , and IMF9 are obtained as shown in FIG. 2, and each IMF having a single characteristic.

S4C2, for each IMF, a deep neural network CNN-BiLSTM-AM is trained with a goal of maximizing the benefit R of scheduling decision of online ride-hailing, to obtain optimal w* and b*; where the CNN mines spatial characteristics of the IMF and a similarity between the spatial characteristics and the features; and the BiLSTM mines a temporal correlation of the IMF. The IMF processed by the CNN and the BiLSTM has a long series, which may influence superiority of the result. The AM may adaptively assign a larger weight to important information in an output series of the BiLSTM, such that computational efficiency and the accuracy of the algorithm are improved.

S4C3, for each trained deep neural network θ_{IMF}(xₙ,d;w*,b*) the corresponding historical number of orders and relevant feature data are input, and the number S_{IMF}* of online hailed rides to be scheduled under each IMF is obtained, which are 405, 484, 258, 247, 218, 291, 137, 80 and 3 respectively.

S4C4, the number of the online hailed rides obtained under each IMF is added, finally the current number s*=1762 of online hailed rides to be scheduled is obtained, and a corresponding income of an online ride-hailing platform is 20128 yuan.

Therefore, by using the deep learning based method for integrating demand forecasting and scheduling of online ride-hailing at a hub, an information loss in an online ride-hailing scheduling decision process is reduced, and a forecast error is prevented from being further amplified in a decision stage.

Finally, it should be noted that the above examples are merely intended to illustrate the technical solution of the present invention and not to limit the same. Although the present invention has been described in detail with reference to the preferred examples, it should be understood by those of ordinary skill in the art that they may still make modifications or equivalent replacements to the technical solutions of the present invention, and the modification or equivalent replacements does not make the modified technical solutions deviate from the spirit and scope of the technical solution of the present invention.

What is claimed is:

1. A deep learning based method for integrating demand forecasting and scheduling of online ride-hailing at a hub, comprising:
S1, performing a data processing: performing missing value filling, outlier processing and normalization processing on historical orders of online ride-hailing and relevant feature data of an urban transportation hub;
S2, performing a feature screening: primarily screening relevant features by means of a Pearson correlation test and box plot analysis, calculating an influence degree of data of each feature on the orders of online ride-hailing by using an XGBoost algorithm, and secondarily screening the features;
S3, performing a model construction: constructing an integrated model for a demand forecasting and scheduling decision of online ride-hailing at the urban transportation hub; and
S4, performing a algorithm design: designing a decision tree and deep learning combination algorithm, and calculating the number of online hailed rides to be scheduled.

2. The deep learning based method for integrating demand forecasting and scheduling of online ride-hailing at the hub according to claim 1, wherein in S1, as for the missing values and outliers in the data, a mean value of data in the same periods in previous three weeks is configured for filling or correction, and a min-max normalization processing is performed on the orders of online ride-hailing and the relevant feature data.

3. The deep learning based method for integrating demand forecasting and scheduling of online ride-hailing at the hub according to claim 2, wherein in S2, Pearson correlation coefficients between continuous time series features and the number of orders are calculated, and features with Pearson coefficients greater than a threshold are retained; and
as for calendar information or binary variable features, box plots are configured for a visual display, features with obvious differences in mean values and quantiles displayed in different dates or different binary variables are retained, the XGBoost algorithm is configured for secondarily screening the relevant features, influence degrees of the preliminarily screened features on the orders of online ride-hailing are calculated and sorted, and some features with accumulated proportion of influence features beyond the threshold are selected.

4. The deep learning based method for integrating demand forecasting and scheduling of online ride-hailing at the hub according to claim 3, wherein in S3, a Douglas function is configured for describing a supply-demand matching process for online ride-hailing with a formula expressed as follows:
$$m ( s , d ) = ⌈ a \times {s}^{{b}_{1}} \times {d}^{{b}_{2}} ⌉$$
wherein d is the number of orders from passengers; s is the supply number of online hailed rides; m is the number of matching successes between the supply number s and the number d of orders; a is a matching technical level; and b₁ and b₂ are matching elastic coefficients;
a benefit R of scheduling decision is maximized as follows:
$$R ( s , d ) = α \times m ( s , d ) - β \times s$$
wherein α is commission drawn by a platform from each matched order, and β is a unit cost of the platform scheduling an online hailed ride to the transportation hub; and
the following integrated model for the demand forecasting and scheduling decision of online ride-hailing is constructed, optimal w* and b* are trained based on xₙ, x and d, and a trained deep neural network θ(xₙ,d;w*,b*) is configured for calculating the number s* of online hailed rides to be scheduled at present:
$$( {w}^{⋆} , {b}^{*} ) = {arg max}_{w , b} {\sum }_{n = 1}^{N} w ( {x}_{n} , x ) R ( θ ( {x}_{n} , d ; w , b ) , {d}_{n} )$$
wherein xₙ is historical relevant feature data, x is current relevant feature data, w(xₙ,x) is a weight value of nth historical orders of online ride-hailing, d={d_{n-L}, . . . , dₙ₋₂,dₙ₋₁} is the historical orders of online ride-hailing with a lag order L, and θ(xₙ,d;w,b) is a deep neural network comprising the weight value w and the threshold b.

5. The deep learning based method for integrating demand forecasting and scheduling of online ride-hailing at the hub according to claim 4, wherein S4 comprises:
S4A, based on a tree structure, determining a similarity between the historical relevant feature data xₙ of the features and the current relevant feature data x of the features layer by layer from a top;
S4B, allocating number-of-orders data with a higher feature similarity to the same branch; and
S4C, using a deep learning algorithm VMD-CNN-BiLSTM-AM for mining a complex nonlinear relation between the relevant features and the number of orders, wherein the deep learning algorithm VMD-CNN-BiLSTM-AM combines a variational modal decomposition (VMD), a convolutional neural network (CNN), a bidirectional long-short-term memory neural network (BiLSTM) and an attention mechanism (AM), and steps are as follows:
S4C1, on the premise of not changing a time correlation, using the VMD to decompose the original number-of-orders data into a plurality of time series data with different frequencies, that is, an intrinsic mode function (IMF);
S4C2, for each IMF, training a deep neural network CNN-BiLSTM-AM with a goal of maximizing the benefit R of scheduling decision of online ride-hailing, to obtain optimal w* and b*;
S4C3, for each trained deep neural network θ_{IMF}(xₙ,d;w*,b*), inputting a corresponding historical number of orders and relevant feature data, and obtaining the number s_{IMF}* of online hailed rides to be scheduled under each IMF; and
S4C4, adding the number of the online hailed rides obtained under each IMF, and obtaining the current number s* of online hailed rides to be scheduled.

6. The deep learning based method for integrating demand forecasting and scheduling of online ride-hailing at the hub according to claim 5, wherein in S4B, a branch assigned to x is denoted as B(x), a weight of the historical number of orders belonging to the same branch as x is denoted as
$$\frac{1}{\vert B ( x ) \vert} ,$$
and the weight of the historical number of orders is denoted as 0, and a formula is expressed as follows:
$${w}_{DT} ( {x}_{n} , x ) := \frac{I \{ {x}_{n} ∈ B ( x ) \}}{\vert B ( x ) \vert} ,$$
wherein I(x) is an indicator function, is equal to 1 when xₙ∈B(x) is true, and is equal to 0 when xₙ∈B(x) is false.
